(19) United States
(12) Patent Application Publication
(10) Pub. No.: US 2026/0316027 A1
(43) Pub. Date: Oct. 15, 2026

(54) Method of Controlling Permeability Through a Mass of Discrete Particulate Matter

(71) Applicant: Ultratech International, Inc., Jacksonville, FL (US)

(72) Inventors: Mark D. Shaw, Ponte Vedra Beach, FL (US); Paul Sander, Jacksonville, FL (US)

(73) Assignee: Ultratech International, Inc., Jacksonville, FL (US)

(21) Appl. No.: 19/461,615

(22) Filed: Jan. 27, 2026

Related U.S. Application Data
(60) Provisional application No. 63/750,013, filed on Jan. 27, 2025.

(51) Int. Cl. B01J 2/30; B01J 2/00

(52) U.S. Cl. CPC B01J 2/30; B01J 2/006

(57) ABSTRACT

A method of controlling, adjusting or varying the rate of liquid permeation through a mass of particles, such as sand, wherein the permeability of liquid through the mass is controlled or adjusted by mixing particles treated with a superhydrophobic solution with particles that have not been treated, thereby decreasing the permeability of the mass.

### BACKGROUND OF THE INVENTION

This invention relates generally to liquid permeation or percolation through a mass of discrete, disconnected particulate matter, such as for example a mass of sand particles. More particularly, the invention relates to a method of controlling, adjusting or varying the rate of liquid permeation through the mass of particles. Even more particularly, the invention relates to such a method wherein the permeability of liquid through the mass is controlled or adjusted by mixing particles treated or coated with a superhydrophobic solution with particles that have not been treated or coated, thereby decreasing the permeability of the mass, i.e., reducing the flow rate as compared to the flow rate of the same mass having no included treated particles.

The term “superhydrophobic” defines a surface having a water contact angle of greater than approximately 150 degrees. The term is also used herein to also define a solution which imparts this characteristic to a surface upon treatment. In contrast, the term “hydrophobic” defines a surface having a contact angle of between approximately 149 degrees to 90 degrees. Both terms refer to a surface which repels water.

The mass of discrete, disconnected particulate matter is best illustrated wherein the particulates are sand particles, sand being defined generally as loose, gritty particles of eroded or weathered rock having a diameter between approximately 1/16 to 4 mm. For ease of reference, the term “sand” shall be used herein to define particulate matter of similar size and having similar chemical, structural or material properties, such as for example small beads of ceramic or glass. Furthermore, the term “treated” shall be used herein to define particulate matter that has been processed to produce superhydrophobic particles, and the term “non-treated” shall be used herein to define particulate matter that has not been processed to produce superhydrophobic particles.

It is an object of this invention to provide individual superhydrophobic sand particles, wherein the treated sand particles are mixed with a quantity of non-treated sand particles to create a mass of discrete particulate members. By mixing the treated sand particles with non-treated sand particles, the permeability of the overall combined mass of sand particles will be reduced. The greater the percentage of added or substituted treated sand relative to the percentage of nontreated sand in the mixture produces a mass of lower permeability in comparison to a similar mass consisting purely of nontreated sand particles.

In addition to reducing the liquid permeability of the mass of sand particles, the method of providing treated sand particles in the mass also reduces the wettability of the mass, i.e., the amount of liquid typically retained within the mass.

### BRIEF SUMMARY OF THE INVENTION

The treated sand particles are created by coating the sand with a superhydrophobic treating solution which adheres to the individual particles but does not bind the particles to each other. A water repellent component capable of producing a superhydrophobic surface is typically combined with water to produce the superhydrophobic treating solution. The treating solution may also contain a crosslinker component and a surfactant component. Such components are known and available in the industry. For example, the superhydrophobic treating solution may be produced by diluting a water repelling product sold by UltraTech International, Inc., under the EVERSHIELD ZERO brand. The superhydrophobic water repellent is added to water in varying amounts depending on the end application and desired reduction in permeability of the particulate mass. The sand particles are then added into the superhydrophobic treating solution, mixed thoroughly, and then oven-dried to heat cure the solution to form a covalently bonded coating or surface layer on the individual sand particles. Excess solution may be retained and reused. Sand particles possessing the superhydrophobic surface layer are referred to herein as “treated”.

The treated sand is then mixed with non-treated sand to produce a discrete mass having a lesser permeability than that of a similar amount of non-treated sand. The degree of reduction in permeability is determined by the ratio of treated sand to non-treated sand, wherein the reduced permeability is directly proportional to the percentage of treated sand present in the mass, such that increasing the percentage of treated sand in the mass reduces the permeability of the mass. In addition, the presence of treated sand in the sand mass reduces wettability, i.e., the amount of liquid retained by the sand mass, and this value, similar to permeability, may also be adjusted by varying the percentage of treated sand in the sand mass.

### DETAILED DESCRIPTION OF THE INVENTION

The invention in various embodiments is a method of controlling or adjusting liquid permeability through a mass of discrete particulate matter, such as sand, small glass beads, small ceramic beads or the like, which will be referred to collectively herein as sand particles. In broad terms, the method comprises the steps of providing a superhydrophobic treating solution, coating sand particles with the solution such that the sand particles are now superhydrophobic, drying the treated sand particles, and mixing the treated sand particles with non-treated sand particles to produce a sand mass having a reduced liquid permeability compared to an equivalent mass of non-treated sand particles. Increasing the percentage of treated sand particles in the mixture decreases the permeability of the mixed sand mass. Decreasing the percentage of treated sand particles in the mixture increases the permeability of the mixed sand mass. In this manner the permeability of the sand mass may be controlled or adjusted to a desired value. In addition, the presence of treated sand in the sand mass reduces wettability, i.e., the amount of liquid retained by the sand mass, and this value, as with permeability, may be adjusted by varying the percentage of treated sand in the sand mass.

The treated sand particles are created by coating the sand with a superhydrophobic solution which adheres to the individual particles but does not bind the particles to each other. A water repellent component capable of producing a superhydrophobic surface is combined with water to produce the superhydrophobic treating solution. The treating solution may also contain a crosslinker component and a surfactant component. Such components are known and available in the industry. For example, the superhydrophobic treating solution may be produced by diluting a waterproofing product sold by UltraTech International, Inc., under the EVERSHIELD ZERO brand.

The amount of water and/or hydrocarbon repellent component present in the treating solution may range from approximately 0.1 wt % to approximately 15 wt %, with the bulk of the treating solution comprising water. A preferred range may be from approximately 0.67 wt % to approximately 6.0 wt %. These ranges may shift depending on whether other components, such cross-linkers or surfactants are present in the treating solution. A suitable treating solution contains EverShield ZERO19, which is a non-fluorinated solution containing water repellant, crosslinking and surfactant components.

The superhydrophobic water repellent is added to water in varying amounts depending on the end application and desired reduction in permeability of the particulate mass. The sand particles are then added into the superhydrophobic treating solution, stirred, vibrated or otherwise manipulated to insure the thorough mixing and full coverage of eh sand particles. The sand particles are then oven-dried to heat cure the solution to form a covalently bonded coating or surface layer on the individual sand particles as well as to dry the particles. Excess solution may be retained and reused. Curing occurs in the approximate temperature range of from 150 to 165 degrees C. It has been found that holding the sand in an oven set at a temperature of approximately 200 degrees C. for approximately 45 minutes will suitably cure the treating solution on the surface of the sand particles and remove any excess treating solution so that the treated sand is thoroughly dried for mixture with the non-treated sand.

The treated sand is then mixed with non-treated sand to produce a discrete mass having a lesser permeability than that of a similar mass of non-treated sand. The degree of reduction in permeability is determined by the ratio of treated sand to non-treated sand, wherein the reduced permeability is directly proportional to the percentage of treated sand present in the mass, such that increasing the percentage of treated sand in the mass reduces the permeability of the mass. For example, a mixture of 5% treated sand with 95% non-treated sand is much more permeable than a mixture of 80% treated sand with 20% non-treated sand. It should also be understood that at high percentages of treated sand relative to non-treated sand, the sand mass may become nearly or completely impermeable unless the liquid pressure is high enough to overcome the resistance to permeability imparted by the treated particles.

The reduction in permeability may also be controlled by altering the concentration of water repellent component present in the treating solution, such that increasing the percentage of the water repellent component results in treated sand particles of greater liquid phobic effect, such that a lesser amount of treated sand particles may be utilized in the sand mass to produce the same reduction in permeability of the sand mass. The higher concentrated treating solution also results in a coating or surface layer which is more durable and long-lasting.

Sand particles are irregular in shape and therefore small gaps occur between adjacent sand particles in the sand mass. A mass of sand particles is permeable to liquid since these gaps interconnect to produce extensive irregular passageways through the sand mass. A property of a superhydrophobic surface is that the water repelling effect of a superhydrophobic surface extends farther from the surface than that of a merely hydrophobic surface because of the higher contact angle. In the sand mass, a superhydrophobic sand particle will effectively reduce or block the gaps between itself and any adjacent nontreated sand particles, preventing water from passing by the superhydrophobic sand particle. In this manner, the presence of many treated sand particles in the mass significantly reduces the number of passageways, thereby reducing permeability and wettability. The higher the percentage of treated sand particles relative to nontreated sand particles in the mass, more passageways are restricted or blocked and the greater the reduction.

In some applications it may be desirable to reduce the permeation or percolation of hydrocarbons, e.g., oil, through the mass of particulate matter in addition to reducing the permeation or percolation of water. To accomplish the superhydrophobic treating solution is formulated such that it is also oleophobic or superoleophobic. Such treating solutions are known and available in the industry. For example, the superhydrophobic and oleophobic or superoleophobic treating solution may be produced by diluting a product sold by UltraTech International, Inc., under the EVERSHIELD DOR brand. The sand particles are then treated in the same manner as described above.

Representative applications and uses include landscaping or agricultural situations where controlled drainage of an underlying sand mass is desired. The superhydrophobic sand could be used in golf course sand traps such that the surface sand remains dry even directly after a rain event. The superhydrophobic and/or superoleophobic sand mass can be used as fracking sand, playground sand, as a surface layer on beaches, or in sand filters for more effective backwashing. The sand may be used in plant containers to retain moisture during transport and display for sale. The superhydrophobic and/or superoleophobic sand can be used to reduce weight during sand transport by retaining less water than non-treated sand alone. Use of the superhydrophobic and/or superoleophobic sand mass in fracking is very promising, as it possesses less weight, has better flow properties, is likely to fill a greater percentage of the fracking cracks when used as a proppant, and will allow the vertical wells to be spaced at greater distances, thereby reducing costs dramatically.

It is to be understood that equivalents and substitutions of components or steps set forth above may be obvious to those of skill in the art, and therefore the true scope and definition of the invention is to be as set forth in the following claims.

We claim:

1. A method of controlling permeability through a mass of discrete particulate matter comprising the steps of producing a quantity of superhydrophobic particles and mixing the superhydrophobic particles with non-superhydrophobic particles.

2. The method of claim 1, wherein the step of producing a quantity of superhydrophobic particles comprises:
treating some of the non-superhydrophobic particles with a solution comprising a superhydrophobic water repellant component.

3. The method of claim 1, wherein the step of producing a quantity of superhydrophobic particles comprises:
treating some of the non-superhydrophobic particles with a solution comprising a superhydrophobic water repellant component, a crosslinking component and a surfactant.

4. The method of claim 2, further comprising the step of treating some of the non-superhydrophobic particles with a treating solution formulated to be superhydrophobic and oleophobic.

5. The method of claim 2, further comprising the step of treating some of the non-superhydrophobic particles with a treating solution formulated to be superhydrophobic and superoleophobic.

6. The method of claim 1, wherein the step of producing a quantity of superhydrophobic particles comprises:
treating some of the non-superhydrophobic particles with a solution comprising a superhydrophobic water repellant component combined with water.

7. The method of claim 6, wherein the superhydrophobic water repellant component is present in a concentration of from approximately 0.1 to 15.0 wt %.

8. The method of claim 6, wherein the superhydrophobic water repellant component is present in a concentration of from approximately 0.67 to 6.0 wt %.

9. A method of controlling permeability through a mass of sand particles comprising the steps of producing a quantity of superhydrophobic sand particles and mixing the superhydrophobic sand particles with non-superhydrophobic sand articles.

10. The method of claim 9, wherein the step of producing a quantity of superhydrophobic sand particles comprises:
treating some of the non-superhydrophobic sand particles with a solution comprising a superhydrophobic water repellant component.

11. The method of claim 9, wherein the step of producing a quantity of superhydrophobic sand particles comprises:
treating some of the non-superhydrophobic particles with a solution comprising a superhydrophobic water repellant component, a crosslinking component and a surfactant.

12. The method of claim 11, further comprising the step of treating some of the non-superhydrophobic particles with a treating solution formulated to be superhydrophobic and oleophobic.

13. The method of claim 11, further comprising the step of treating some of the non-superhydrophobic sand particles with a treating solution formulated to be superhydrophobic and superoleophobic.

14. The method of claim 9, wherein the step of producing a quantity of superhydrophobic sand particles comprises:
treating some of the non-superhydrophobic sand particles with a solution comprising a superhydrophobic water repellant component combined with water.

15. The method of claim 14, wherein the superhydrophobic water repellant component is present in a concentration of from approximately 0.1 to 15.0 wt %.

16. The method of claim 14, wherein the superhydrophobic water repellant component is present in a concentration of from approximately 0.67 to 6.0 wt %.
